(19) United States
(12) Patent Application Publication
(10) Pub. No.: US 2016/0165214 A1
(43) Pub. Date: Jun. 9, 2016

(54) IMAGE PROCESSING APPARATUS AND MOBILE CAMERA INCLUDING THE SAME

(71) Applicant: LG INNOTEK CO., LTD., Seoul (KR)

(72) Inventor: Sung Phil KIM, Seoul (KR)

(21) Appl. No.: 14/962,756

(22) Filed: Dec. 8, 2015

(30) Foreign Application Priority Data
Dec. 8, 2014 (KR) 10-2014-0174924

(51) Int. Cl. H04N 13/02; H04N 5/33

(52) U.S. Cl. CPC H04N 13/0253; H04N 13/0271; H04N 13/0214; H04N 5/332

(57) ABSTRACT

Disclosed is an image processing apparatus which includes a light projection unit for projecting infrared light having a predetermined pattern onto an object, an image acquisition unit for absorbing light having a visible-light band and transmitting light having an infrared wavelength band to acquire an image having a target pattern projected onto the object, and an image processing unit for obtaining information on 3D distance of the object using the light acquired by the image acquisition unit.

### CROSS REFERENCE TO RELATED APPLICATION

This application claims the benefit under 35 U.S.C. §119 to Korea Patent Application No. 10-2014-0174924, filed Dec. 8, 2014, which is hereby incorporated by reference in its entirety.

### TECHNICAL FIELD

Embodiments relate to an image processing apparatus and a mobile camera including the same.

### BACKGROUND

Three-dimensional (3D) object recognition technology is one of the principal fields of interest in computer vision. Basically, such 3D distance measurement technology includes projecting a light pattern onto an object scene in which a target object to be recognized is positioned, acquiring an image projected onto the object scene to three-dimensionally restore the target object positioned in the object scene, and measuring a 3D distance.

In this case, light having an infrared wavelength band is transmitted through an infrared filter, and light having a visible-light wavelength band is blocked by the infrared filter to acquire the projected image. Conventional infrared filters have a drawback in that wavelengths of transmitted light may be shifted because incident light strays from a vertical direction due to use of an infrared band pass filter using a multi-coating method. Therefore, since a camera module should be designed so that a chief ray angle (CRA) of the camera module approaches ‘0°,’ it may be difficult to reduce a total track length (TTL) of optical lenses, which make it impossible to manufacture a slim image processing apparatus, and it may also be difficult to integrate the image processing apparatus with other applied products in a built-in manner.

### BRIEF SUMMARY

Embodiments provide an image processing apparatus having a chief ray angle (CRA) whose range is widened, and a mobile camera including the same.

In one embodiment, an image processing apparatus includes a light projection unit for projecting infrared light having a predetermined pattern onto an object, an image acquisition unit for absorbing light having a visible-light band and transmitting light having an infrared wavelength band to acquire an image having a target pattern projected onto the object, and an image processing unit for obtaining information on a three-dimensional (3D) distance of the object using the light acquired at the image acquisition unit.

For example, the infrared light may have a wavelength band of 800 nm to 850 nm.

For example, the light projection unit may include a light source for emitting the infrared light, and a pattern generation unit for providing the predetermined pattern to the emitted infrared light to project the emitted infrared light.

For example, the pattern generation unit may include a light diffusion plate for diffusing light emitted from the light source.

For example, the image acquisition unit may include an image sensor for converting optical signals into electrical signals, a lens unit for focusing the image having the target pattern on the image sensor, and an infrared filter arranged between the image sensor and the lens unit to absorb light having a visible-light band and transmit light having an infrared wavelength band.

For example, the infrared filter for transmitting the infrared light having a wavelength band of a first wavelength to a second wavelength may include a first dye for absorbing light having a wavelength band less than the first wavelength and transmitting light having a wavelength band greater than or equal to the first wavelength, and a second dye for absorbing light having a wavelength band of the second wavelength to a third wavelength and transmitting light having a wavelength band less than the second wavelength or greater than the third wavelength.

For example, the infrared filter may include a substrate, and a first dye layer arranged on the substrate in a direction in which the image is acquired and including the first and second dyes. Here, the first dye layer may include the first and second dyes in a mixed form. In addition, the first dye layer may include a 1-1^{st} dye layer including the first dye, and a 1-2^{nd} dye layer including the second dye and arranged to overlap the 1-1^{st} dye layer in a direction in which the image is acquired.

For example, in addition, the infrared filter may include a substrate including the first and second dyes.

For example, the infrared filter may further include a second dye layer in the form of a multilayered thin film.

For example, the first dye layer may have front and rear surfaces facing the object and the substrate, respectively. The second dye layer may be arranged on the front surface of the first dye layer, and may also be positioned on the rear surface of the first dye layer so that the second dye layer is arranged between the substrate and the first dye layer. In addition, the substrate may have front and rear surfaces facing the first dye layer and the image sensor, respectively. In this case, the second dye layer may be arranged on the rear surface of the substrate.

For example, The substrate may be made of at least one material selected from the group consisting of plastic and glass.

For example, the image processing unit may include a distance generation unit for obtaining the information on 3D distance using the light acquired by the image acquisition unit, and may further include a map generation unit for generating a 3D map of the object using the information on 3D distance obtained by the distance generation unit.

For example, the image processing apparatus may further include a housing for holding the light projection unit and the image acquisition unit.

In another embodiment, a mobile camera includes the image processing apparatus.

### BRIEF DESCRIPTION OF THE DRAWINGS

Arrangements and embodiments may be described in detail with reference to the following drawings in which like reference numerals refer to like elements and wherein:

FIG. 1 is a block diagram showing an image processing apparatus according to one embodiment;

FIG. 2 is a graph illustrating quantum efficiency according to wavelengths of light;

FIGS. 3A to 3D are graphs for explaining an operation of an infrared filter shown in FIG. 1;

FIGS. 4A to 4F are diagrams showing embodiments of the infrared filter shown in FIG. 1;

FIG. 5 is a cross-sectional view locally showing a lens unit, an infrared filter, and an image sensor in an image processing apparatus according to a comparative embodiment; and

FIG. 6 is a cross-sectional view locally showing a lens unit, an infrared filter, and an image sensor in the image processing apparatus according to the embodiment.

### DETAILED DESCRIPTION

Hereinafter, embodiments will be described with reference to the annexed drawings. However, it should be understood that the following embodiments may be changed in various forms, and thus are not intended to limit the scope of the disclosure. Thus, the embodiments are provided to describe the disclosure more completely, as apparent to those skilled in the art.

For description of the disclosure, it will be understood that when an element is referred to as being “on” or “under” another element, it can be directly on/under the element, and one or more intervening elements may also be present.

When an element is referred to as being “on” or “under”, “under the element” as well as “on the element” can be included based on the element.

In addition, the relative terms “first,” “second,” “top,” “bottom,” etc. used herein may only be used to distinguish any entities or elements from each other without requiring or encompassing any physical or logical relationship between or order of the entities or elements.

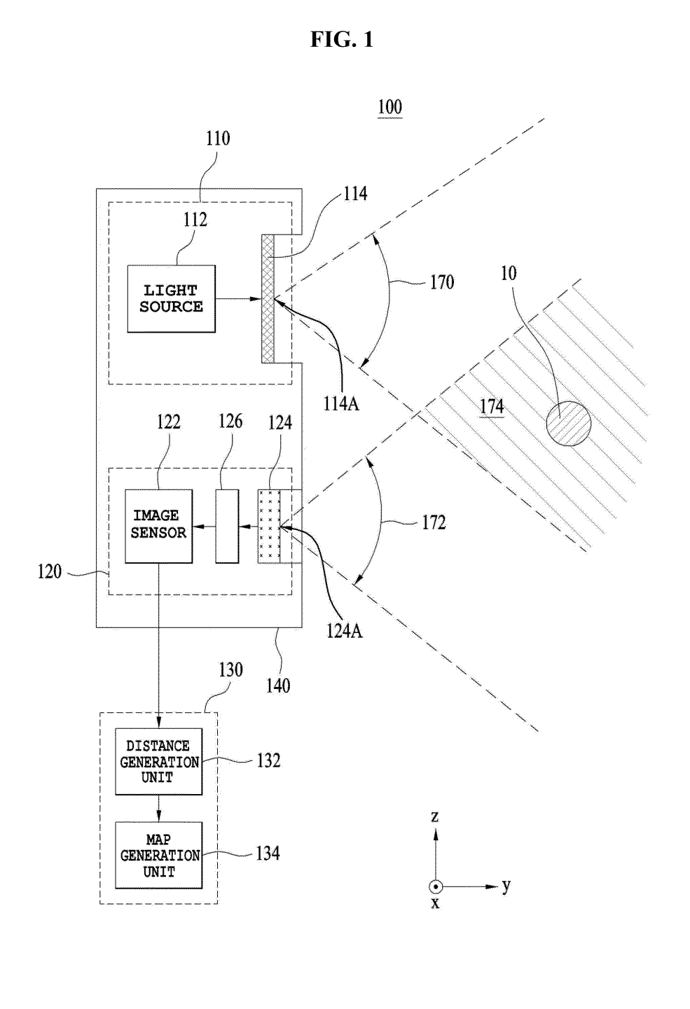

FIG. 1 is a block diagram showing an image processing apparatus 100 according to one embodiment.

The image processing apparatus 100 shown in FIG. 1 may include a light projection unit 110, an image acquisition unit 120, an image processing unit 130, and a housing 140.

The light projection unit 110 may serve to project infrared light having a predetermined pattern onto an object 10. For example, the infrared light may have a wavelength band of 800 nm to 850 nm, but embodiments are not limited thereto.

The light projection unit 110 may include a light source 112 and a pattern generation unit 114.

The light source 112 may serve to emit infrared light. For example, the light source 112 may be a coherent light source, and may be realized with a laser, but embodiments are not limited to the shape of the light source 112.

The pattern generation unit 114 serves to provide a predetermined pattern to the infrared light emitted from the light source 112, and projects infrared light having the predetermined pattern. For this purpose, the pattern generation unit 114 may, for example, include a light diffusion plate. The light diffusion plate serves to diffuse light emitted from the light source 112 to provide a predetermined pattern to infrared light. The pattern may be in the form of spots 114A, but embodiments are not limited thereto. For example, infrared light having various patterns may be projected onto the object 10. For example, diverging beams 170 may be generated by passing light emitted from the light source 112 through the light diffusion plate via spots 114A.

Meanwhile, the image acquisition unit 120 may serve to absorb light having a visible-light wavelength band and transmit light having an infrared wavelength band to acquire an image having a target pattern projected onto the object 10. For this purpose, the image acquisition unit 120 may include an image sensor 122, a lens unit 124, and an infrared filter 126.

The image sensor 122 serves to convert optical signals into electrical signals and to output the converted electrical signals to the image processing unit 130. For example, the image sensor 122 may be a charge-coupled device (CCD) or complementary metal-oxide semiconductor (CMOS) image sensor array in which detecting devices are arranged in a matrix pattern.

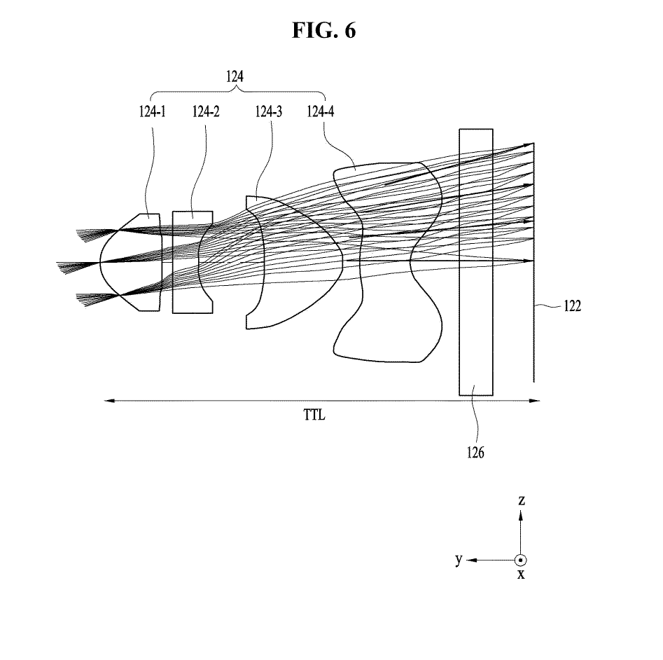

The lens unit 124 serves to focus the image having the target pattern present on the object 10 onto the image sensor 122. The lens unit 124 may include objective lenses for optics, but embodiments are not limited thereto. According to another embodiment, the lens unit 124 may include a plurality of lenses as will be shown later in FIG. 6. The lens unit 124 includes entrance pupils 124A, and may be used together with the image sensor 122 to define a field of view 172 of the image with respect to the target pattern. A sensing volume of the image processing apparatus 100 may include the diverging beams 170 and a volume 174 overlapping the field of view 172.

The infrared filter 126 is arranged between the image sensor 122 and the lens unit 124 to absorb and block light having a visible-light wavelength band and transmit light having an infrared wavelength band. Here, the infrared wavelength band may be in a range of a first wavelength λ1 to a second wavelength λ2. For example, the first wavelength λ1 may be 800 nm, and the second wavelength λ2 may be 850 nm, but embodiments are not limited thereto.

The infrared filter 126 according to one embodiment may include first and second dyes.

The first dye serves to absorb light having a wavelength band less than the first wavelength λ1 (or less than or equal to the first wavelength λ1), and to transmit light having a wavelength band greater than or equal to the first wavelength λ1 (or greater than the first wavelength λ1).

The second dye serves to absorb and block light having a wavelength band greater than or equal to the second wavelength λ2 (or greater than the second wavelength λ2) and less than or equal to a third wavelength λ3 (or less than the third wavelength λ3), and transmit light having a wavelength band less than the second wavelength λ2 (or less than or equal to the second wavelength λ2) and greater than the third wavelength λ3 (or greater than or equal to the third wavelength λ3).

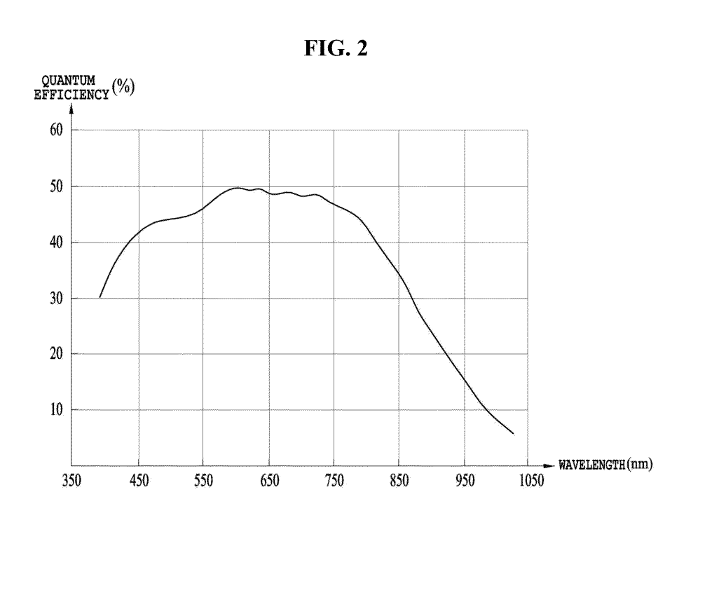

FIG. 2 is a graph illustrating quantum efficiency according to wavelengths of light. Here, the longitudinal axis represents quantum efficiency, and the horizontal axis represents wavelength.

The third wavelength λ3 is determined as any value falling within a wavelength band which is as low as negligible and within which quantum efficiency of light is very low. For example, referring to FIG. 2, when the third wavelength λ3 is greater than or equal to 950 nm, quantum efficiency is as low as negligible. Therefore, the third wavelength λ3 may be equal to 950 nm. For example, the third wavelength λ3 may be greater than or equal to 1,100 nm, but embodiments are not limited thereto.

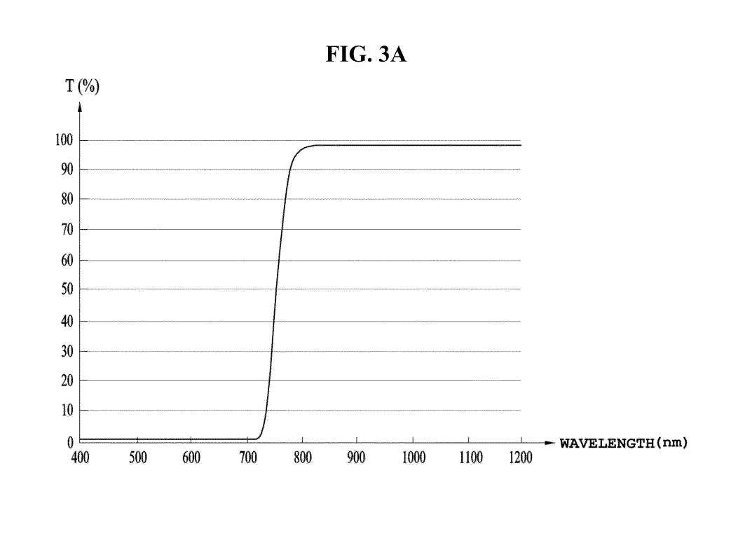

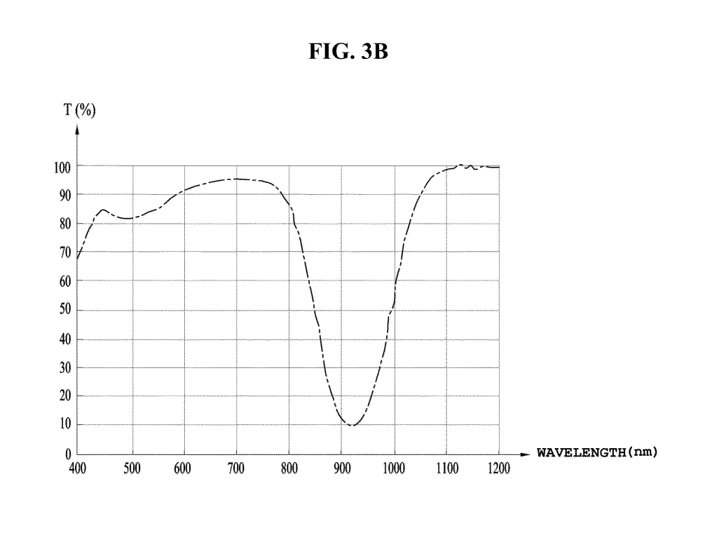

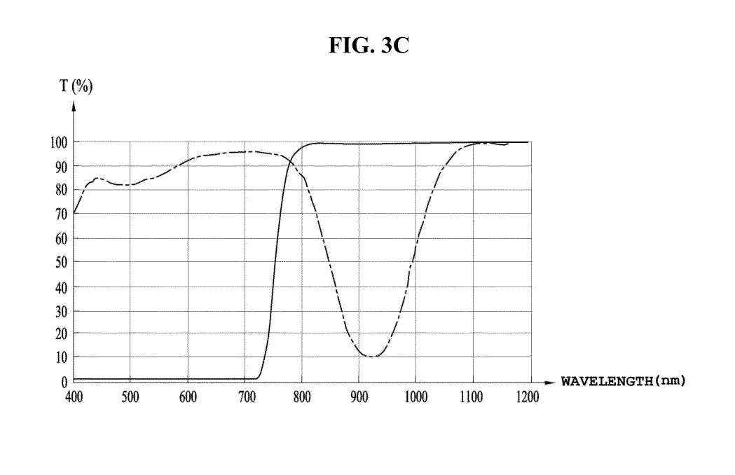

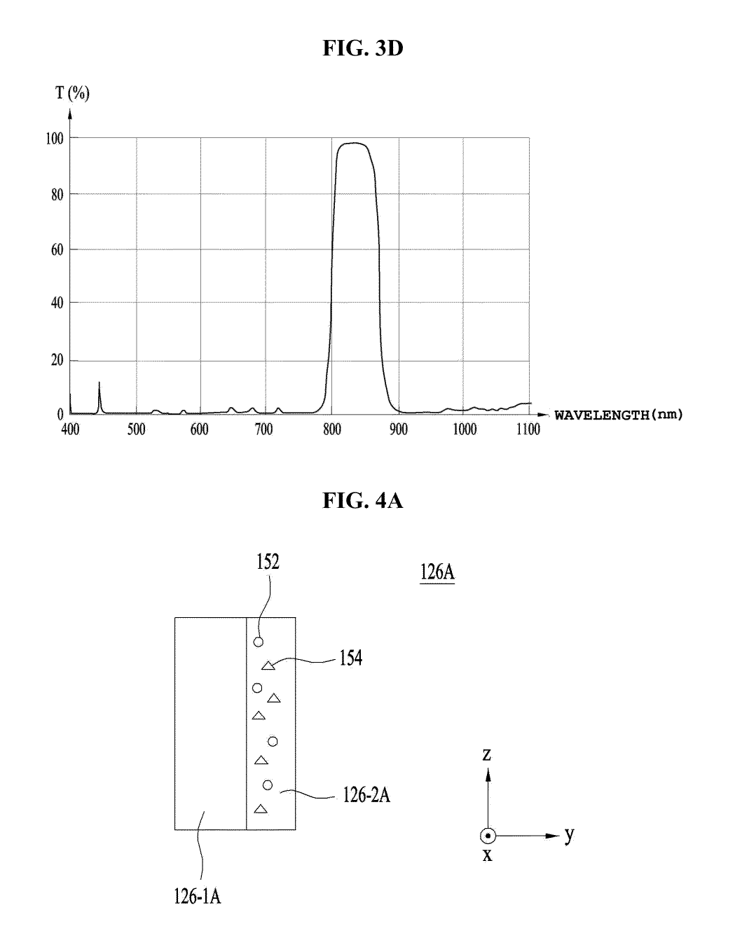

FIGS. 3A to 3D are graphs for explaining an operation of the infrared filter 126 shown in FIG. 1, FIG. 3A is a graph for explaining absorption and transmission of light by means of the first dye, FIG. 3B is a graph for explaining absorption and transmission of light by means of the second dye, FIG. 3C is a graph for explaining absorption and transmission of light by means of the first and second dyes in a mixed form, and FIG. 3D is a graph for explaining absorption and transmission of light by means of the infrared filter 126. In each graph, the horizontal axis represents wavelength, and the longitudinal axis represents transmittance T.

Referring to FIG. 3A, the first dye may absorb and block light having a wavelength band less than the first wavelength λ1, for example, 800 nm, and transmit light having a wavelength band greater than or equal to 800 nm. Referring to FIG. 3B, the second dye may absorb and block light having wavelengths falling within a wavelength band greater than or equal to the second wavelength λ2, for example, 850 nm, and less than or equal to the third wavelength λ3, for example, 1,100 nm, and transmit light having wavelengths falling within a wavelength band less than 850 nm or greater than 1,100 nm. When the first and second dyes having such characteristics are mixed as shown in FIG. 3C, the infrared filter 126 may transmit infrared light having wavelengths falling within a wavelength band of from the first wavelength λ1 to the second wavelength λ2, that is, a wavelength band from 800 nm to 850 nm, and block light having the other wavelengths by absorbing the light having the other wavelengths, as shown in FIG. 3D.

When the infrared filter 126 includes the first and second dyes as described above, the infrared filter 126 may transmit light having wavelengths falling within a desired infrared wavelength band, and absorb and block light having wavelengths falling within the other wavelength bands. The first and second dyes may be included in the infrared filter 126 in various forms. Hereinafter, various embodiments of the infrared filter 126 will be described in detail with reference to the accompanying drawings, as follows.

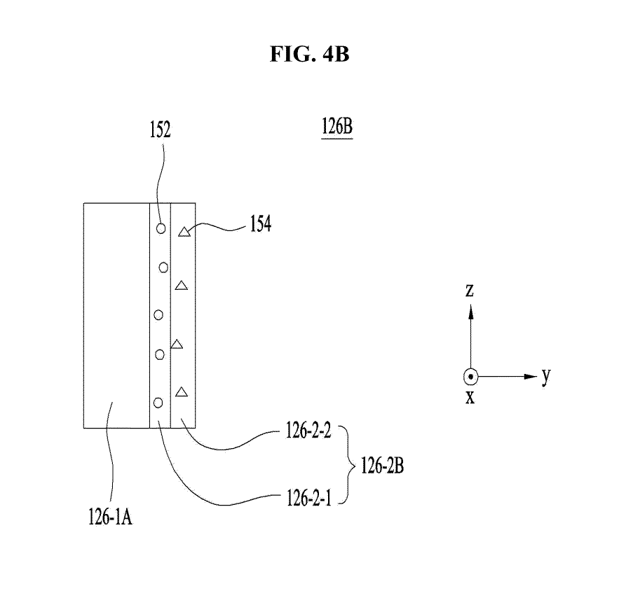

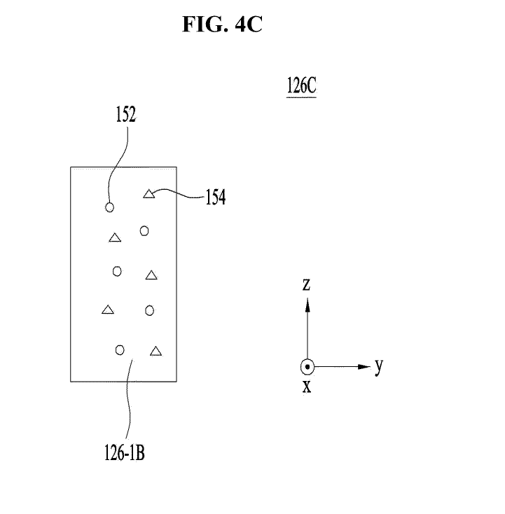

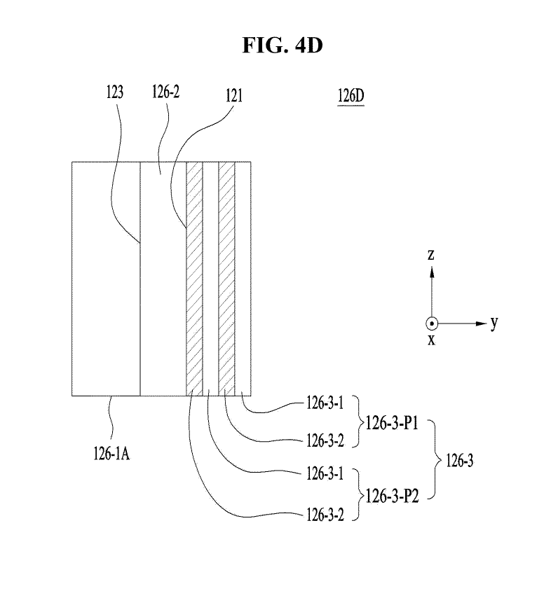

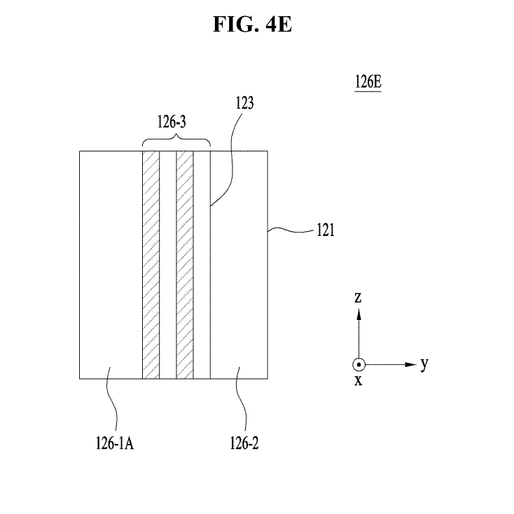

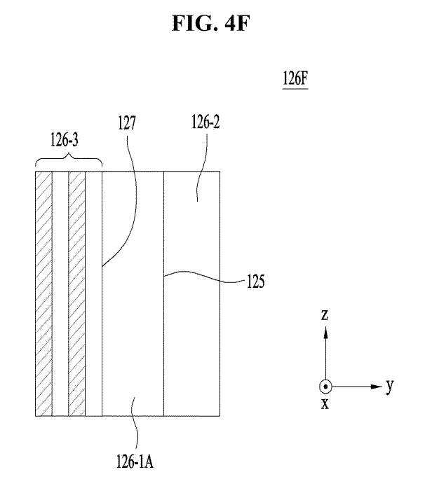

FIGS. 4A to 4F are diagrams showing embodiments (126A to 126F) of the infrared filter 126 shown in FIG. 1.

As sown in FIG. 4A or 4B, the infrared filter 126A or 126B may include a substrate 126-1A, and a first dye layer 126-2A or 126-2B. In addition, the infrared filter 126C may include only a substrate 126-1B, as shown in FIG. 4C. Additionally, each of the infrared filters 126D to 126F may include a substrate 126-1A, a first dye layer 126-2, and a second dye layer 126-3, as shown in FIGS. 4D to 4F.

The embodiments (126A to 126F) of the infrared filter 126 will be described in further detail, as follows.

Referring to FIGS. 4A and 4B, the infrared filter 126A or 126B may include a substrate 126-1A, and a first dye layer 126-2A or 126-2B. The first dye layer 126-2A or 126-2B may be arranged on the substrate 126-1A in a direction (e.g., a y-axis direction) in which an image is acquired, and may include first and second dyes.

For example, the first dye layer 126-2A may include a first dye 152 and a second dye 154 in a mixed form, as shown in FIG. 4A.

Or, the first dye layer 126-2B may include a 1-1^{st} dye layer 126-2-1 and a 1-2^{nd} dye layer 126-2-2, as shown in FIG. 4B. The 1-1^{st} dye layer 126-2-1 may include the first dye 152, and the 1-2^{nd} dye layer 126-2-2 may include the second dye 154. In this case, the 1-1^{st} dye layer 126-2-1 and the 1-2^{nd} dye layer 126-2-2 may be arranged on the substrate 126-1A to overlap each other in a direction (e.g., a y-axis direction) in which the image is acquired.

A case in which the 1-1^{st} dye layer 126-2-1 is arranged between the substrate 126-1A and the 1-2^{nd} dye layer 126-2-2 is shown in FIG. 4B, but embodiments are not limited thereto. That is, according to another embodiment, the 1-2^{nd} dye layer 126-2-2 may be arranged between the substrate 126-1A and the 1-1^{st} dye layer 126-2-1.

In addition, the infrared filter 126C may be realized only with the substrate 126-1B including the first and second dyes 152 and 154, as shown in FIG. 4C.

Further, each of the infrared filters 126D to 126F may further include the second dye layer 126-3 in the form of a multilayered thin film, as shown in FIGS. 4D to 4F.

In FIGS. 4D to 4F, the first dye layer 126-2 may correspond to the first dye layer 126-2A or 126-2B shown in FIG. 4A or 4B. Or, a configuration having the substrate 126-1A and the first dye layer 126-2, as shown in FIGS. 4D to 4F, may be replaced with a configuration where the first dye layer 126-2A or 126-2B is omitted but the substrate 126-1B includes the first and second dyes 152 and 154, as shown in FIG. 4C.

In FIGS. 4D and 4E, the first dye layer 126-2 may have a front surface 121 facing the object 10, and a rear surface 123 facing the substrate 126-1A. In this case, the second dye layer 126-3 may be arranged on the front surface 121 of the first dye layer 126-2, as shown in FIG. 4D.

Or, the second dye layer 126-3 may be arranged on the rear surface 123 of the first dye layer 126-2 so that the second dye layer 126-3 is arranged between the substrate 126-1A and the first dye layer 126-2, as shown in FIG. 4E.

Further, in FIG. 4F, the substrate 126-1A may have a front surface 125 facing the first dye layer 126-2, and a rear surface 127 facing the image sensor 122. In this case, the second dye layer 126-3 may be arranged on the rear surface 127 of the substrate 126-1A.

The second dye layer 126-3 may have a shape in which two material films (or material layers) having different refractive indexes are repeatedly stacked in an alternating manner. For example, the second dye layer 126-3 may include first and second pairs 126-3-P1 and 126-3-P2, as shown in FIGS. 4D to 4F. Here, each of the first and second pairs 126-3-P1 and 126-3-P2 may include first and second layers 126-3-1 and 126-3-2. The first and second layers 126-3-1 and 126-3-2 may be made of semiconductor materials, or oxide films thereof. For example, the first layer 126-3-1 may be a silicon film, and the second layer 126-3-2 may be a silicon oxide film. For example, the first layer 126-3-1 as the silicon film may be made of polysilicon, amorphous silicon, or single-crystal silicon. The first layer 126-3-1 is preferably made of polysilicon.

A case in which the second dye layer 126-3 includes only the two pairs 126-3-P1 and 126-3-P2 is shown in FIGS. 4D to 4F, but embodiments are not limited thereto. For example, the second dye layer 126-3 may include one pair, or two or more pairs.

Each of the first dye layers 126-2A, 126-2B, and 126-2 and the second dye layer 126-3 as described above may be coupled to the substrate 126-1A in a coated or applied form, but embodiments are not limited to coupling of the first dye layers 126-2A, 126-2B, and 126-2 and the second dye layer 126-3 to the substrate 126-1A.

The substrates 126-1A and 126-1B shown in FIGS. 4A to 4F may be made of at least one material selected from the group consisting of plastic and glass, but embodiments are not limited to certain materials of the substrates 126-1A and 126-1B.

Meanwhile, referring again to FIG. 1, the image processing unit 130 may serve to obtain the information on 3D distance of the object 10 using the light acquired by the image acquisition unit 120. For this purpose, the image processing unit 130 may include a distance generation unit 132. The distance generation unit 132 may serve to obtain the information on 3D distance of the object 10 using the light acquired by the image acquisition unit 120.

In addition, the image processing unit 130 may further include a map generation unit 134. Here, the map generation unit 134 may serve to generate a 3D map of the object 10 using the information on 3D distance obtained by the distance generation unit 132. Here, the term “3D map” may refer to a series of 3D coordinates representing a surface of the object 10. For example, the map generation unit 134 may be realized with hardware, but may also be realized with software stored in memories associated with an image processor. Here, the memories may correspond to look-up tables. The 3D map thus generated may be used for various purposes. For example, the 3D map may be displayed to users. The displayed image may be a virtual 3D image.

Meanwhile, the housing 140 may serve to hold the light projection unit 110 and the image acquisition unit 120. Optionally, the image processing apparatus 100 may not include the housing 140. Owing to arrangement of the housing 140, the center of the entrance pupils 124A may be spaced apart from the center of the spots 114A, and the axes passing through the centers of the entrance pupils 124A and the spots 114A may be parallel with one of the axes of the image sensor 122.

Hereinafter, the image processing apparatuses according to the comparative embodiment and the embodiment will be described in detail with reference to the accompanying drawings, as follows.

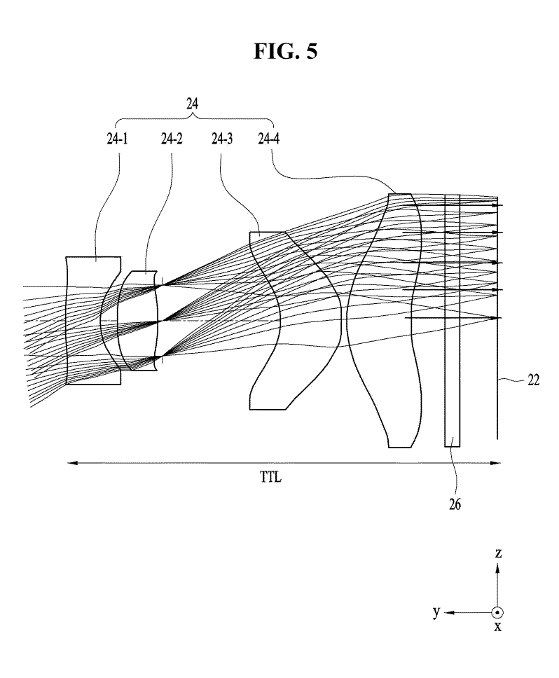

FIG. 5 is a cross-sectional view locally showing a lens unit 24, an infrared filter 26, and an image sensor 22 in the image processing apparatus according to the comparative embodiment.

FIG. 6 is a cross-sectional view locally showing a lens unit 124, an infrared filter 126, and an image sensor 122 in the image processing apparatus 100 according to the embodiment.

Referring to FIG. 5, first, the lens unit 24 may include a plurality of lenses 24-1, 24-2, 24-3, and 24-4. The lenses 24-1, 24-2, 24-3, and 24-4 serve to transmit, refract and collimate the target pattern to output the target pattern through the infrared filter 26, as shown in FIG. 5. The infrared filter 26 may be realized as an infrared band pass filter in order to filter only light having an infrared wavelength band from the light passing through the lens unit 24 and provide the filtered light to the image sensor 22.

However, since such an infrared band pass filter may be manufactured using a multi-coating method, the wavelengths of light may be shifted as incident light stray from a vertical direction. Therefore, the image acquisition unit should be designed so that the chief ray angle (CRA) of the image acquisition unit approaches ‘0°.’ When the CRA approaches ‘0°,’ this may function to restrict the design of the image acquisition unit, which makes it difficult to reduce a total track length (TTL) of optical lenses. Therefore, since it may be difficult to reduce the TTL, it may be impossible to manufacture a slim image processing apparatus, and it may also be difficult to build the image processing apparatus in other applied products.

In addition, there is a difference in interference results according to an angle of incident light in consideration of the basic principle of an interference effect in case of the multilayered thin film filter realized as the infrared filter 26. Therefore, characteristics of light incident on the infrared filter 26 may be significantly varied by an angle of incidence of the light.

On the other hand, referring to FIG. 6, the lens unit 124 according to one embodiment may include a plurality of lenses 124-1, 124-2, 124-3, and 124-4, as shown in FIG. 5. Here, the plurality of lenses 124-1, 124-2, 124-3, and 124-4 serve to receive an image having a target pattern, subject the target pattern of the image to at least one of transmission, refraction, or collimation, and then output the target pattern through the infrared filter 26.

As described above, the infrared filter 126 may serve to transmit only light having wavelengths falling within an infrared wavelength band, and absorb and block light having wavelengths falling within a visible-light wavelength band. That is, the infrared filter 126 may serve to transmit only light having a wavelength band of 800 nm to 850 nm, and absorb and block light having the other wavelength bands. As described above, since the light having the visible-light wavelength band is absorbed and blocked, variation in the characteristics of light caused by the angle of incidence in the image processing apparatus according to the comparative embodiment shown in FIG. 5 may be prevented in the case of the image processing apparatus according to the embodiment.

As a result, the image processing apparatus according to the embodiment may remove fatal limitations on the design of the slim lens unit 124 by extending a CRA range, compared to the image processing apparatus according to the comparative embodiment shown in FIG. 5. For example, when the image processing apparatus 100 is applied to mobile cameras, the CRA may be in a range of approximately 0 to 45°, preferably 5° to 45°. For example, the CRA may be 30°.

In addition, the thickness of the image acquisition unit 120, that is, a camera of the image processing apparatus 100 may be reduced as the slim lens unit 124 is manufactured.

Additionally, design flexibility of the image acquisition unit 120, for example, a camera module, may be enhanced, and manufacturing costs may be curtailed due to an increase a margin of tolerance.

Further, the thickness of the applied products in which the image processing apparatus 100 is used may be reduced as the slim image processing apparatus 100 is manufactured, and thus, the image processing apparatus 100 may be easily integrated with the applied products.

The image processing apparatuses according to the above-described embodiments may be applied to televisions, computers, tablet PCs, smartphones, motion sensing modules, 3D structure sensing modules, etc.

As is apparent from the above description, the image processing apparatus according to the embodiments, and the mobile camera including the same can transmit light having an infrared wavelength band while absorb and block light having a visible-light wavelength band, and thus can have effects of preventing variation in characteristics of light caused by an angle of incidence, which has been considered as one of the problems occurring in the band pass filter, extending a CRA range and reducing the thickness thereof when compared to the conventional image processing apparatuses, enhancing design flexibility of the image acquisition unit, for example, a camera module, curtailing manufacturing costs due to an increase the margin of tolerance, reducing the thickness of the applied products to which the image processing apparatus is applied, and easily integrating the image processing apparatus with the applied products in a built-in manner.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image processing apparatus, comprising:
a light projection unit projecting infrared light having a predetermined pattern onto an object;
an image acquisition unit absorbing light having a visible-light band and transmitting light having an infrared wavelength band to acquire an image having a target pattern projected onto the object; and
an image processing unit obtaining information on a three-dimensional (3D) distance of the object using the light acquired by the image acquisition unit.

2. The image processing apparatus of claim 1, wherein the infrared light has a wavelength band of 800 nm to 850 nm.

3. The image processing apparatus of claim 1, wherein the light projection unit comprises:
a light source emitting the infrared light; and
a pattern generation unit providing the predetermined pattern to the emitted infrared light to project the emitted infrared light.

4. The image processing apparatus of claim 3, wherein the pattern generation unit comprises a light diffusion plate diffusing light emitted from the light source.

5. The image processing apparatus of claim 1, wherein the image acquisition unit comprises:
an image sensor converting optical signals into electrical signals;
a lens unit focusing the image having the target pattern onto the image sensor; and
an infrared filter arranged between the image sensor and the lens unit to absorb light having a visible-light band and to transmit light having an infrared wavelength band.

6. The image processing apparatus of claim 5, wherein the infrared filter transmitting the infrared light having a wavelength band of a first wavelength to a second wavelength comprises:
a first dye for absorbing light having a wavelength band less than the first wavelength and transmitting light having a wavelength band greater than or equal to the first wavelength; and
a second dye for absorbing light having a wavelength band of the second wavelength to a third wavelength and transmitting light having a wavelength band less than the second wavelength or greater than the third wavelength.

7. The image processing apparatus of claim 6, wherein the infrared filter comprises:
a substrate; and
a first dye layer arranged on the substrate in a direction in which the image is acquired and comprising the first and second dyes.

8. The image processing apparatus of claim 7, wherein the first dye layer comprises the first and second dyes in a mixed form.

9. The image processing apparatus of claim 7, wherein the first dye layer comprises:
a 1-1^{st} dye layer comprising the first dye; and
a 1-2^{nd} dye layer comprising the second dye and arranged to overlap the 1-1^{st} dye layer in a direction in which the image is acquired.

10. The image processing apparatus of claim 6, wherein the infrared filter comprises a substrate comprising the first and second dyes.

11. The image processing apparatus of claim 7, wherein the infrared filter further comprises a second dye layer in the form of a multilayered thin film.

12. The image processing apparatus of claim 11, wherein the first dye layer has front and rear surfaces facing the object and the substrate, respectively.

13. The image processing apparatus of claim 12, wherein the second dye layer is arranged on the front surface of the first dye layer.

14. The image processing apparatus of claim 12, wherein the second dye layer is positioned on the rear surface of the first dye layer so that the second dye layer is arranged between the substrate and the first dye layer.

15. The image processing apparatus of claim 11, wherein the substrate has front and rear surfaces facing the first dye layer and the image sensor, respectively, and the second dye layer is arranged on the rear surface of the substrate.

16. The image processing apparatus of claim 7, wherein the substrate is made of at least one material selected from the group consisting of plastic and glass.

17. The image processing apparatus of claim 1, wherein the image processing unit comprises a distance generation unit obtaining the information on 3D distance using the light acquired by the image acquisition unit.

18. The image processing apparatus of claim 17, wherein the image processing unit further comprises a map generation unit generating a 3D map of the object using the information on 3D distance obtained by the distance generation unit.

19. The image processing apparatus of claim 1, further comprising a housing for holding the light projection unit and the image acquisition unit.

20. A mobile camera comprising the image processing apparatus defined in claim 1.
